(19) United States
(12) Patent Application Publication
(10) Pub. No.: US 2016/0080617 A1
(43) Pub. Date: Mar. 17, 2016

(54) IMAGE CAPTURING DEVICE

(71) Applicants: LITE-ON ELECTRONICS (GUANGZHOU) LIMITED, GUANGZHOU (CN); LITE-ON TECHNOLOGY CORP., TAIPEI (TW)

(72) Inventors: ZONG-SIAN LI, TAIPEI (TW); CHING-HUAN LIAO, TAIPEI (TW)

(21) Appl. No.: 14/706,175

(22) Filed: May 7, 2015

(30) Foreign Application Priority Data
Sep. 12, 2014 (CN) 201410466250.4

(51) Int. Cl. H04N 5/225

(52) U.S. Cl. CPC H04N 5/2254; H04N 5/2258; H04N 5/2256

(57) ABSTRACT

An image capturing device includes at least one lens unit and an image sensor. The at least one lens unit includes a main lens, a first reflective lens and a second reflective lens. The first reflective lens has a first reflective surface that is configured to receive light which passes through the main lens into the image capturing device. The second reflective lens has a second reflective surface that is configured to receive light reflected from the first reflective surface. The image sensor is configured to receive and sense light reflected from the second reflective surface. The second reflective surface and the first reflective surface are non-parallel to each other.

### CROSS-REFERENCE TO RELATED APPLICATION

This application claims priority of Chinese Application No. 201410466250.4, filed on Sep. 12, 2014.

### FIELD

The disclosure relates to an image capturing device, more particularly to an image capturing device having a plurality of reflective lenses.

### BACKGROUND

Currently, a digital camera module includes a lens element for receiving light, and an image sensor (or photosensitive element) for sensing the light. The image sensor is generally classified into a charge-coupled device (CCD) and a complementary metal-oxide-semiconductor (CMOS) active pixel sensor.

It is a research and development goal of manufacturers to devote efforts on widening the field of view of the digital camera module.

### SUMMARY

Therefore, an object of the disclosure is to provide an image capturing device that is capable of widening the field of view thereof.

According to the disclosure, an image capturing device includes at least one lens unit and an image sensor. The at least one lens unit includes a main lens, a first reflective lens and a second reflective lens. The first reflective lens has a first reflective surface that is configured to receive light which passes through the main lens into the image capturing device. The second reflective lens has a second reflective surface that is configured to receive light reflected from the first reflective surface. The image sensor is configured to receive and sense light reflected from the second reflective surface. The second reflective surface and the first reflective surface are non-parallel to each other.

### BRIEF DESCRIPTION OF THE DRAWINGS

Other features and advantages of the disclosure will become apparent in the following detailed description of the embodiments with reference to the accompanying drawings, of which:

FIG. 1 is a schematic view of a first embodiment of an image capturing device according to the disclosure;

FIG. 2 is a schematic view, illustrating the first embodiment shooting a plurality of objects;

FIG. 3 is a schematic view of an image captured by the first embodiment;

FIG. 4 is a schematic view of an image captured by the first embodiment when the arrangement of first and second reflective lenses of the image capturing device is altered;

FIG. 5 is a schematic view of a second embodiment of an image capturing device according to the disclosure;

FIG. 6 is a schematic view of an image captured by the second embodiment;

FIG. 7 is a schematic view, illustrating an image obtained after processing an image of FIG. 5;

FIG. 8 is a schematic view of a third embodiment of an image capturing device according to the disclosure; and

FIG. 9 is a schematic view of an image captured by the third embodiment.

### DETAILED DESCRIPTION

Before the disclosure is described in greater detail, it should be noted that like elements are denoted by the same reference numerals throughout the disclosure.

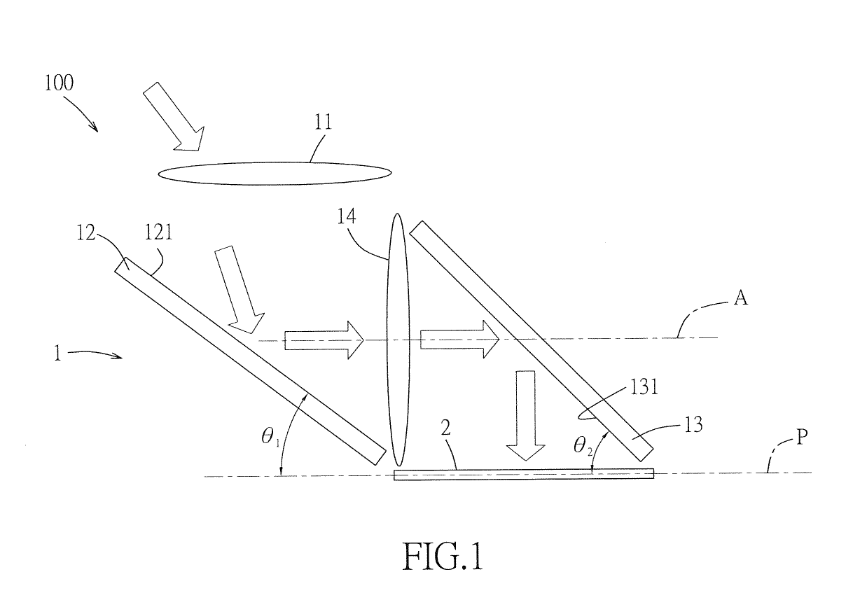

Referring to FIG. 1, a first embodiment of an image capturing device 100 according to the disclosure includes a lens unit 1 and an image sensor 2. The image sensor 2 defines a plane (P)

The lens unit 1 includes a main lens 11, a first reflective lens 12, a second reflective lens 13, and an aberration correction lens 14. The first reflective lens 12 has a first reflective surface 121 that is configured to receive light which passes through the main lens 11 into the image capturing device 100. The aberration correction lens 14 is configured to correct an aberration caused by the main lens 11 when the light passes therethrough. In this embodiment, the aberration correction lens 14 is disposed between the first and second reflective lenses 12, 13 for passage therethrough of the light reflected from the first reflective surface 121. The second reflective lens 13 has a second reflective surface 131 that is configured to receive the light which is reflected from the first reflective surface 121 and which passes through the aberration correction lens 14. The second reflective surface 131 and the first reflective surface 121 are non-parallel to each other. The second reflective surface 131 and the first reflective surface 121, when extrapolated, form an included angle that is greater than 0 degree but less than 15 degrees. In this embodiment, the second reflective surface 131 and the plane (P) form an included angle (θ₂) of 45 degrees. For this reason, an included angle (θ₁) between the first reflective surface 121 and the plane (P) ranges between 30 degrees and 60 degrees. In addition, the aberration correction lens 14 has an axis (A) parallel with the plane (P), and the included angle (θ₁) between the first reflective surface 121 and the plane (P) is 35 degrees (i.e., less than 45 degrees). That is to say, the included angle between the second reflective surface 131 and the first reflective surface 121 is 10 degrees.

The image sensor 2 is configured to receive and sense the light reflected from the second reflective surface 131. In this embodiment, the image sensor 2 can be one of a charge-coupled device (CCD) and a complementary metal-oxide-semiconductor (CMOS) active pixel sensor. Arrows shown in FIG. 1 are used to illustrate a path of the light.

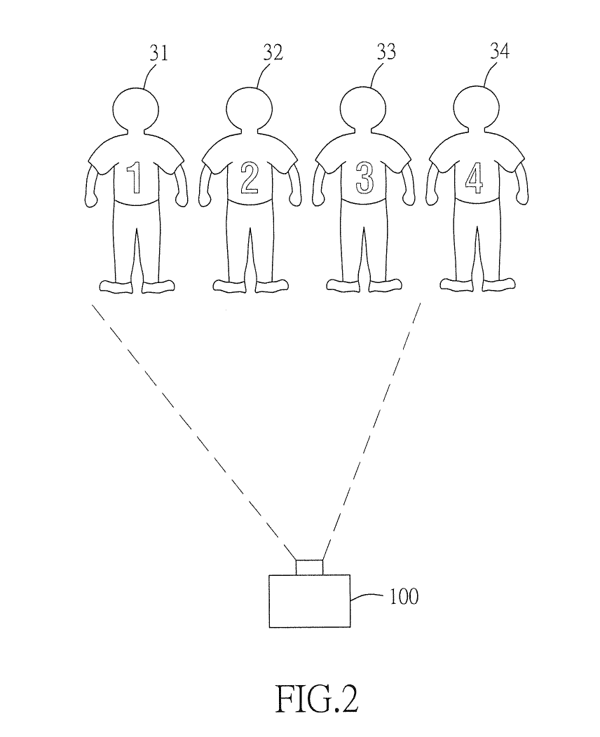

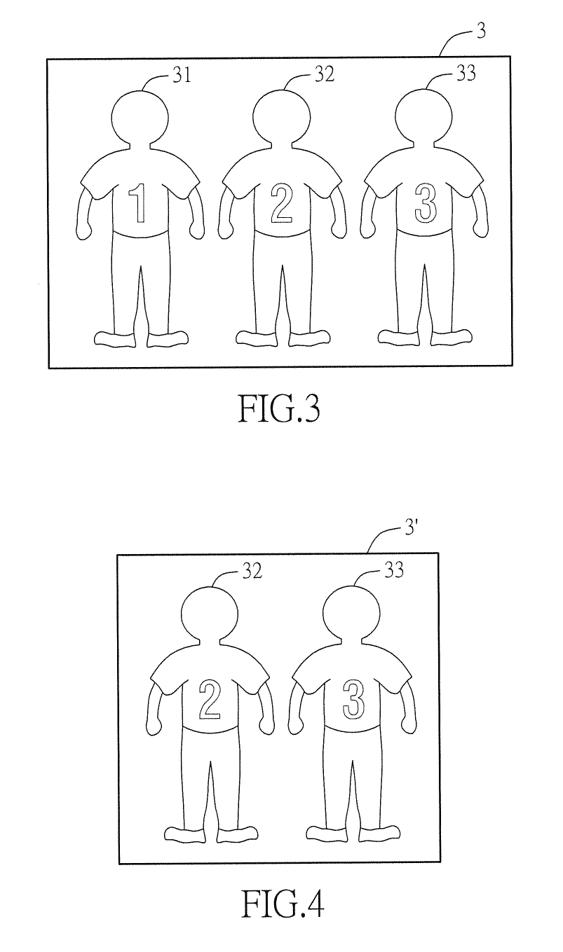

Referring to FIG. 2, when the image capturing device 100 is used to shoot a plurality of objects 31, 32, 33 and 34, the image sensor 2 can capture an image 3, as shown in FIG. 3. The image 3 includes the objects 31, 32 and 33.

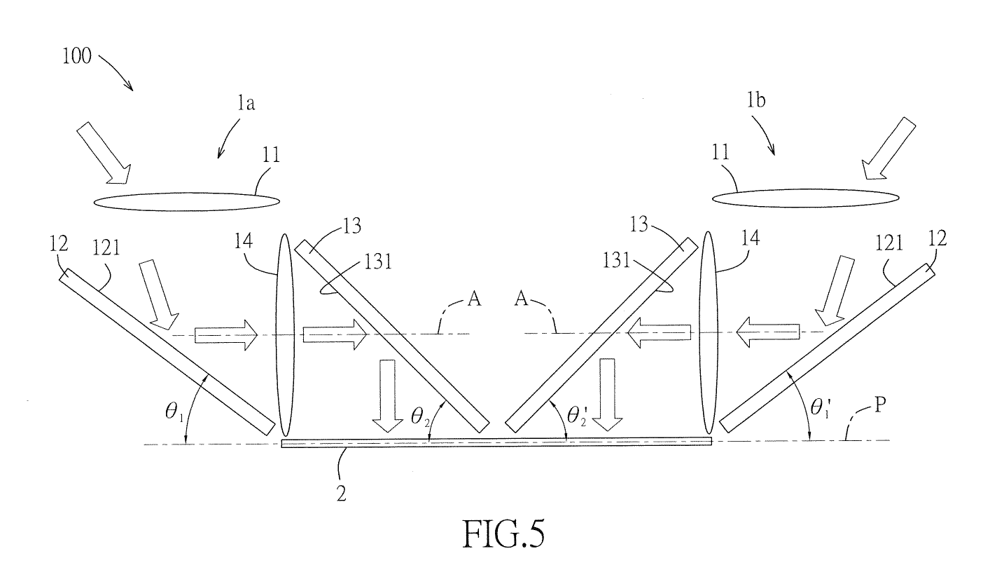

An image 3′ shown in FIG. 4 is captured by the image sensor 2 when the first reflective lens 12 of the first embodiment is adjusted such that the first reflective surface 121 is parallel to the second reflective surface 131. In comparing FIG. 4 and FIG. 3, the image 3′ shown in FIG. 4 lacks the object 31 which is included in the image 3 shown in FIG. 3. In other words, the image 3′ shown in FIG. 4 has a field of view that is narrower than that of the image 3 shown in FIG. 3. Based on the first embodiment, by virtue of a non-parallel structure of the second reflective surface 131 and the first reflective surface 121, a field of view of the captured image can be effectively widened.

FIG. 5 illustrates the second embodiment of an image capturing device 100 according to the disclosure, which has a configuration similar to that of the first embodiment. The main difference between the first and second embodiments resides in that the image capturing device 100 of the second embodiment includes two lens units (1a, 1b). In this embodiment, preferably, an included angle)(θ₁′) between the first reflective surface 121 of the lens unit (1b) and the plane (P) is equal to the included angle (θ₁) between the first reflective surface 121 of the lens unit (1a) and the plane (P). Further, an included angle) (θ₂′) formed between the second reflective surface 131 of the lens unit (1b) and the plane (P) is equal to the included angle (θ₂) formed between the second reflective surface 131 of the lens unit (1a) and the plane (P). That is, θ₁=θ₁′ and θ²=θ₂′, but is not limited thereto. That is to say, θ₁ may not be equal to θ₁′, and θ₂ may not be equal to θ₂′.

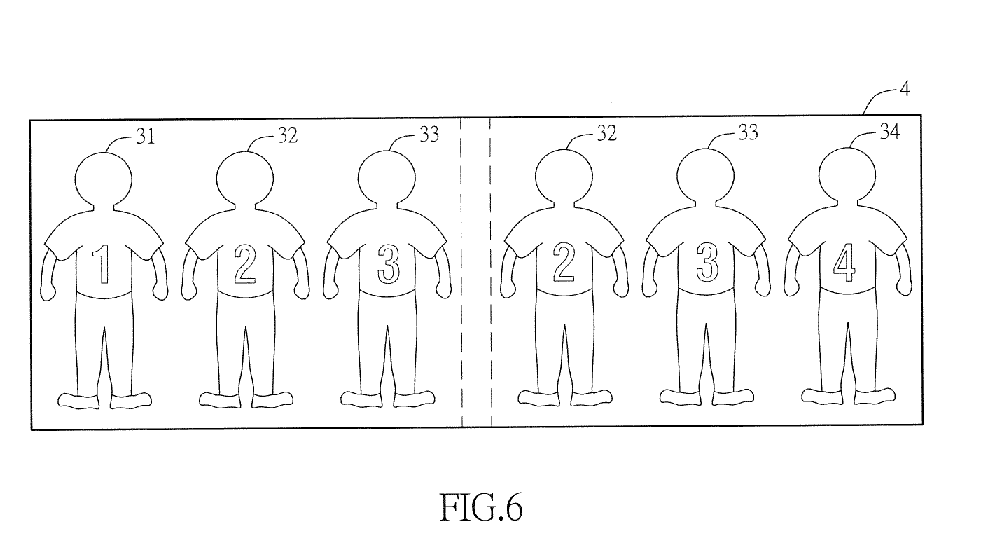

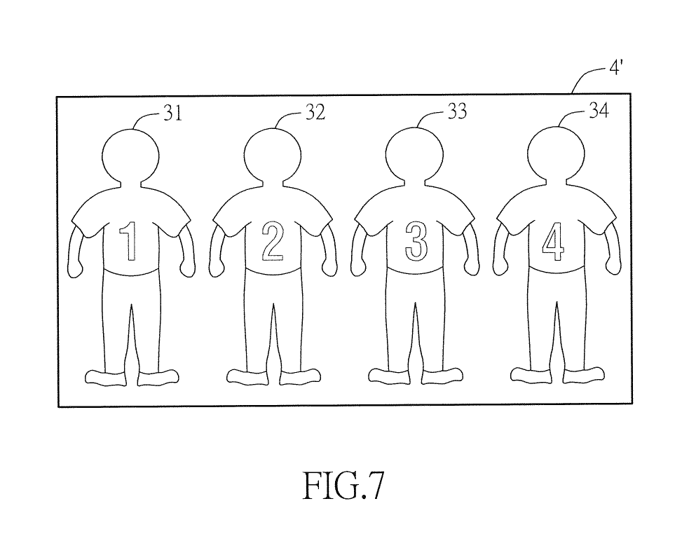

In this embodiment, the image sensor 2 senses an image 4, as shown in FIG. 6. A left half of the image 4 is captured through the lens unit (1a) and includes objects 31, 32, and 33. A right half of the image 4 is captured through the lens unit (1b) and includes objects 32, 33, and 34. The image 4 shown in FIG. 6 can be processed by an image processing unit (not shown) of the image capturing device 100 (for example, using an image stitching technique) to generate an image 4′, as shown in FIG. 7. The image 4′ includes the objects 31, 32, 33, and 34. In this embodiment, by virtue of a structural arrangement of the lens units (1a and 1b), a field of view of the captured image can be further widened.

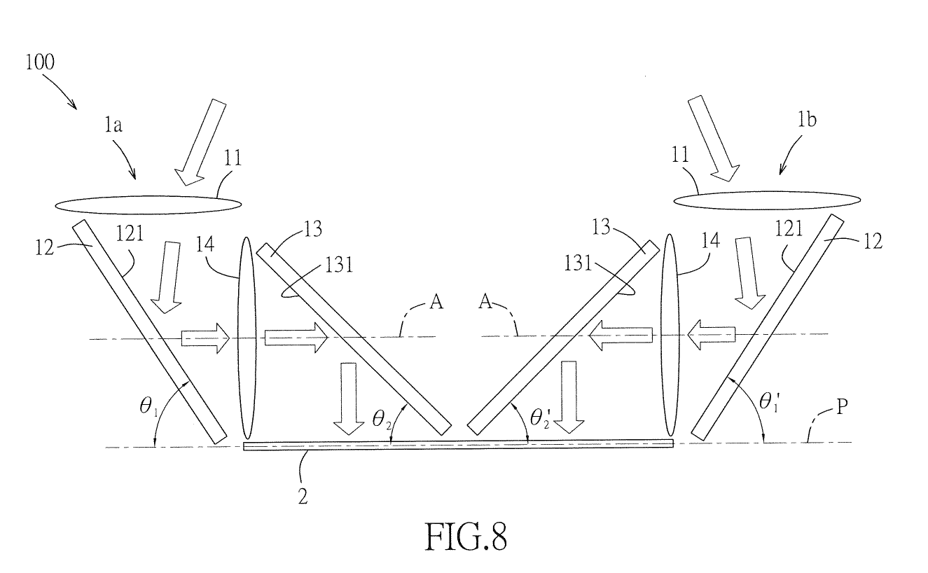

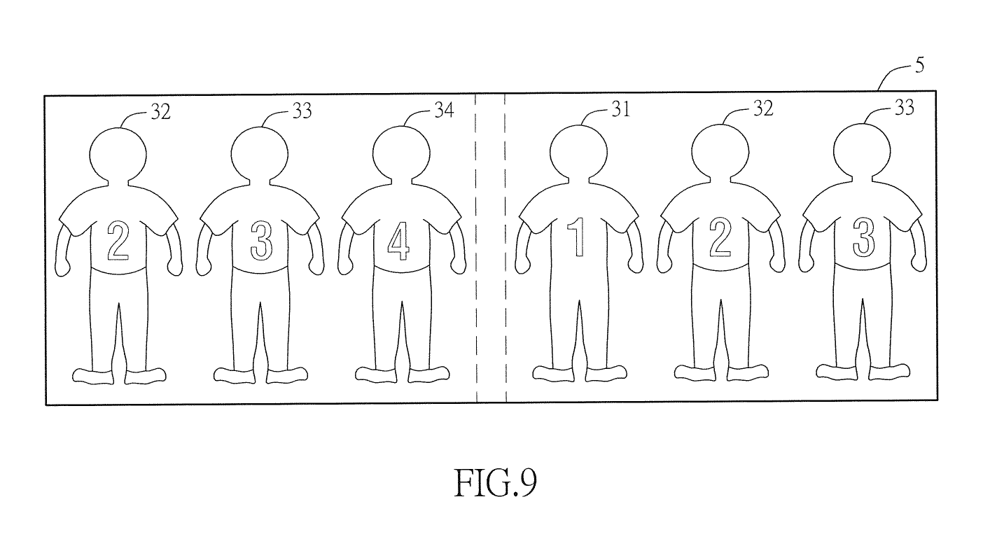

FIG. 8 illustrates the third embodiment of an image capturing device 100 according to the disclosure, which has a configuration similar to that of the second embodiment. The main difference between the second and third embodiments resides in the arrangement of the first reflective lens 12 of each of the lens units (1a and 1b). In this embodiment, the included angle (θ₁) between the first reflective surface 121 of each of the lens units (1a and 1b) and the plane (P) is 55 degrees (i.e., greater than 45 degrees). The included angle formed between the second reflective surface 131 and the first reflective surface 121 of each of the lens units (1a and 1b) when extrapolated is 10 degrees.

In this embodiment, the image sensor 2 senses an image 5, as shown in FIG. 9. A left half of the image 5 is captured through the lens unit (1a) and includes objects 32, 33, and 34. A right half of the image 4 is captured through the lens unit (1b) and includes objects 31, 32, and 33. Since the included angle (θ₁) between the first reflective surface 121 of each of the lens units (1a and 1b) and the plane (P) is greater than 45 degrees, the objects on the left and right halves of the image 5 are opposite to those of the image 4 (see FIG. 6) of the second embodiment. Similar to the second embodiment, the image 5 shown in FIG. 9 can be processed by the image processing unit (not shown) of the image capturing device 100 so as to generate the image 4′, as shown in FIG. 7. A width of the field of view in this embodiment is same as that in the second embodiment.

Additionally, the image capturing device 100 may further include a mechanism (not shown) for adjusting an inclination angle of the first reflective lens 12 and/or the second reflective lens 13, so that a user can adjust the width of the field of view through adjustment of the inclination angle of the first reflective lens 12 and/or the second reflective lens 13.

To sum up, by virtue of the nonparallel arrangement of the second reflective surface 131 and the first reflective surface 121 of the image capturing device 100, the image sensor 2 can sense the image with a wider field of view than that of the conventional image capturing device. Further, by virtue of the arrangement of the two lens units (1a and 1b), the field of view can be further widened. In addition, through the aberration correction lens 14, the aberration caused by the main lens 11 when the light passes therethrough can be effectively corrected.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An image capturing device, comprising:
at least one lens unit that includes a main lens, a first reflective lens and a second reflective lens, said first reflective lens having a first reflective surface that is configured to receive light which passes through said main lens into said image capturing device, said second reflective lens having a second reflective surface that is configured to receive light reflected from said first reflective surface; and
an image sensor that is configured to receive and sense light reflected from said second reflective surface;
wherein said second reflective surface and said first reflective surface are non-parallel to each other.

2. The image capturing device as claimed in claim 1, wherein said second reflective surface and said first reflective surface, when extrapolated, form an included angle that is greater than 0 degree but less than 15 degrees.

3. The image capturing device as claimed in claim 1, wherein said at least one lens unit further includes an aberration correction lens that is configured to correct an aberration caused by said main lens when the light passes therethrough.

4. The image capturing device as claimed in claim 3, wherein said aberration correction lens is disposed between said first and second reflective lenses for passage therethrough of the light reflected from said first reflective surface.

5. The image capturing device as claimed in claim 4, wherein said image sensor defines a plane, said second reflective surface and said plane forming an included angle of 45 degrees, said aberration correction lens having an axis parallel with said plane.

6. The image capturing device as claimed in claim 5, wherein an included angle between said first reflective surface and said plane is less than 45 degrees.

7. The image capturing device as claimed in claim 5, wherein an included angle between said first reflective surface and said plane is greater than 45 degrees.

8. The image capturing device as claimed in claim 5, wherein an included angle between said first reflective surface and said plane ranges between 30 degrees and 60 degrees.

9. The image capturing device as claimed in claim 1, wherein said at least one lens unit includes a plurality of said lens units.
